(19) United States
(12) Patent Application Publication
(10) Pub. No.: US 2024/0218922 A1
(43) Pub. Date: Jul. 4, 2024

(54) SPEED REDUCER, SPEED-REDUCING TRANSMISSION MECHANISM, AND ROBOT JOINT AND ROBOT INCLUDING THE SPEED-REDUCING TRANSMISSION MECHANISM

(71) Applicants: SHANGHAI FLEXIV ROBOTICS TECHNOLOGY CO., LTD., Shanghai (CN); FLEXIV LTD., Grand Cayman, Cayman Islands (GB)

(72) Inventors: Ran AN, Santa Clara, CA (US); Tingke SONG, Shanghai (CN); Shiquan WANG, Santa Clara, CA (US)

(21) Appl. No.: 17/997,297

(22) PCT Filed: Dec. 16, 2021
(86) PCT No.: PCT/CN2021/138697

§ 371 Date: Oct. 27, 2022

(30) Foreign Application Priority Data
Dec. 13, 2021 (CN) 202111522002.3

(51) Int. Cl. F16H 49/00; B25J 9/10

(52) U.S. Cl. CPC F16H 49/001; B25J 9/102; F16H 2049/003

(57) ABSTRACT

The present disclosure relates to a speed reducer, a speed-reducing transmission mechanism, and a robot joint and a robot including the speed-reducing transmission mechanism. The speed reducer is configured to achieve a reduction transmission from a transmission input shaft to a transmission output shaft, and includes: a wave generator mounted to the transmission input shaft; a fixed circular spline; and a flexspline located between the circular spline and the wave generator, and including a gear portion and a flange portion. The flange portion is configured to be connected to the transmission output shaft.

### CROSS-REFERENCE TO RELATED APPLICATIONS

This application claims to the priority of Chinese Patent Application No. 2021115220023, filed on Dec. 13, 2021, the entire contents of which is incorporated herein by reference.

### TECHNICAL FIELD

The present disclosure relates to the technical field of speed reducers, in particular to a speed reducer, a speed-reducing transmission mechanism, and a robot joint and a robot including the speed-reducing transmission mechanism.

### BACKGROUND

Recently, robotics has been developed very fast. Since robots can handle some highly precise, complex and repetitive tasks, and greatly reduce time of human operations and human efforts, the robots are widely used in industrial production. As a reducing mechanism that reduces the rotating speed and increases the torque, a harmonic speed reducer is generally used in the robot, to adjust a moving speed and an output torque of each arm of the robot to achieve harmonic reduction transmission. The harmonic reduction transmission is a new type of mechanical transmission that relies on the controllable elastic deformation generated by a flexspline to cause relative staggered teeth between teeth of a circular spline and teeth of the flexspline to transmit motion and force. The harmonic speed reducer generally includes a wave generator, a circular spline and a flexspline. Cross roller bearings and other parts can further be integrated inside the harmonic speed reducer.

Generally, when the wave generator of the harmonic speed reducer is driven by a shaft of a motor to rotate at a high speed, the wave generator rotates and presses the flexspline to cause the flexspline to rotate at a low speed, and in turn, other loaded components connected to the flexspline or circular spline are driven to rotate. During this process, one end of the flexspline is usually fixed, and the circular spline is connected to other loaded components and drives the other loaded components to rotate. For example, as shown in FIG. 1, in a speed-reducing transmission mechanism 1000, a motor 1 is fixedly connected to a transmission input shaft 2, and the transmission input shaft 2 is fixedly connected to the wave generator 3. In this way, the motor 1 can drive the transmission input shaft 2 to rotate synchronously, so that the motor 1, the transmission input shaft 2 and the wave generator 3 can rotate synchronously. The wave generator 3, the circular spline 4 and the flexspline 5 form a harmonic speed reducer. The flexspline 5 has a cylindrical structure and has a flange portion, and is fixed to a housing of the speed-reducing transmission mechanism 1000. The circular spline 4 is connected to other loaded components and is rotated to drive the other loaded components. Therefore, when the wave generator 3 is driven by the motor 1 to rotate at a high speed, the wave generator 3 can drive the circular spline 4 to rotate at a low speed, and in turn, the circular spline 4 can drive other loaded components to rotate, thereby realizing the reduction transmission.

However, in the configuration of the harmonic speed reducer, since the flange portion of the flexspline 5 is fixed to the housing of the speed-reducing transmission mechanism 1000 in a direction toward the motor 1, and the flexspline 4 is connected to other loaded components and is rotated to drive the other loaded components. Therefore, when the flexspline 5 is assembled to the transmission input shaft 2, the inward flange portion and the cylindrical portion of the flexspline 5 will have to occupy a part of the mounting space of the transmission input shaft 2, resulting in an inevitably longer length of the transmission input shaft 2. Thus, the transmission input shaft 2 has a larger weight, such that the weight and the moment of inertia of the kinetic energy input end of the entire speed-reducing transmission mechanism 1000 are both larger during an operating process, affecting the dynamic response of the speed-reducing transmission mechanism 1000.

### SUMMARY

According to various embodiments, a speed reducer, a speed-reducing transmission mechanism, and a robot joint and a robot including the speed-reducing transmission mechanism are provided.

According to an aspect of the present disclosure, a speed reducer is configured to achieve a reduction transmission from a transmission input shaft to a transmission output shaft, and includes: a wave generator mounted to the transmission input shaft; a fixed circular spline; and a flexspline located between the circular spline and the wave generator, and including a gear portion and a flange portion. The flange portion is configured to be connected to the transmission output shaft.

In one of the embodiments, a loaded component is connected to the flange portion.

In one of the embodiments, the wave generator includes a cam.

In one of the embodiments, a distance from the flange portion to a center rotational axis of the transmission input shaft is greater than a distance from the circular spline to the center rotational axis of the transmission input shaft.

According to another aspect of the present disclosure, a speed-reducing transmission mechanism is provided. The speed-reducing transmission mechanism includes: a transmission input shaft; a motor mounted at one end of the transmission input shaft; a speed reducer mounted at the other end of the transmission input shaft, and including a wave generator, a circular spline, and a flexspline located between the circular spline and the wave generators; and a transmission output shaft connected to the flexspline. The circular spline is fixedly connected. The flexspline includes a gear portion and a flange portion. The flange portion is connected to the transmission output shaft, to achieve a reduction transmission from the transmission input shaft to the transmission output shaft.

In one of the embodiments, a loaded component is connected to the flexspline.

In one of the embodiments, the flange portion may face a side of the wave generator away from the motor.

In one of the embodiments, the wave generator may be mounted on the other end of the transmission input shaft. The motor, the transmission input shaft, and the wave generator may rotate synchronously.

In one of the embodiments, the wave generator includes a cam.

In one of the embodiments, the speed-reducing transmission mechanism may further include a housing. The circular spline is fixed to the housing.

In one of the embodiments, a distance from the flange portion to a center rotational axis of the transmission input shaft may be greater than a distance from the circular spline to the center rotational axis of the transmission input shaft.

In one of the embodiments, the loaded component is directly connected to the flange portion of the flexspline via a fastener.

In one of the embodiments, the speed-reducing transmission mechanism may further include a connecting member. The connecting member may be connected to the flange portion of the flexspline via a fastener, and is fixedly connected to the transmission output shaft.

In one of the embodiments, a loaded component may be fixedly connected to the connecting member.

In one of the embodiments, the loaded component and the connecting member may be two independent components, or may be integrally formed.

In one of the embodiments, the connecting member may be provided with a first mounting hole. The flange portion may be provided with a second mounting hole. A position of the first mounting hole corresponds to a position of the second mounting hole. A loaded component and the connecting member are connected to the flange portion via the fastener.

In one of the embodiments, the speed-reducing transmission mechanism may further include a support bearing mounted on the transmission input shaft.

In one of the embodiments, one support bearing is provided.

In one of the embodiments, the speed-reducing transmission mechanism may further include a cross roller bearing provided between the flange portion of the flexspline and the circular spline.

In one of the embodiments, a bearing oil seal is provided at one end of the cross roller bearing away from the flange portion.

In one of the embodiments, the transmission input shaft and the transmission output shaft are coaxially mounted. The transmission input shaft is sleeved over the transmission output shaft.

In one of the embodiments, the fastener is a screw, or a bolt.

According to another aspect of the present disclosure, a robot joint is provided. The robot joint includes the speed-reducing transmission mechanism according to any one of the embodiments.

According to another aspect of the present disclosure, a robot is provided. The robot includes the robot joint as described above.

Details of one or more embodiments of the present disclosure will be given in the following description and attached drawings. Other features, objects and advantages of the present disclosure will become apparent from the description, drawings, and claims.

### BRIEF DESCRIPTION OF THE DRAWINGS

In order to more clearly describe the technical solutions in the embodiments of the present disclosure, the drawings required in the embodiments will be briefly introduced below. Apparently, the drawings in the following description only illustrate some embodiments of the present disclosure. For those of ordinary skill in the art, other drawings can be obtained from these drawings without creative work.

FIG. 1 is a schematic diagram of a speed-reducing transmission mechanism according to prior art.

FIG. 2 is a partial cross-sectional schematic view of the speed-reducing transmission mechanism according to prior art.

FIG. 3 is a schematic diagram of a speed-reducing transmission mechanism according to the present disclosure.

FIG. 4 is a partial cross-sectional schematic view of the speed-reducing transmission mechanism according to the present disclosure.

### DETAILED DESCRIPTION OF THE EMBODIMENTS

In order to enable the above objects, features and advantages of the present disclosure more obvious and understandable, the specific embodiments of the present disclosure will be described in detail below with reference to the accompanying drawings. In the following description, many specific details are illustrated in order to aid in understanding of the present disclosure. However, the present disclosure can be implemented in many other ways different from those described herein, and those skilled in the art can make similar improvements without departing from the connotation of the present disclosure. Therefore, the present disclosure is not limited by the specific embodiments disclosed below.

In the description of the present disclosure, it should be understood that orientation or positional conditions indicated by terms “center”, “length”, “width”, “thickness”, “upper”, “lower”, “front”, “rear”, “left”, “right”, “axial”, “radial”, etc. are based on orientation or positional relationships shown in the drawings, which are merely to facilitate the description of the present disclosure and simplify the description, not to indicate or imply that the device or elements should have a particular orientation, be constructed and operated in a particular orientation, and therefore cannot be construed as a limitation on the present disclosure.

In the present disclosure, unless explicitly specified and defined otherwise, terms “mounting”, “connecting”, “connected”, and “fixing” should be understood in a broad sense. For example, it may be a fixed connection or a detachable connection, or an integration; may be a mechanical connection or electrical connection; may be a direct connection, or may be a connection through an intermediate medium, may be the communication between two elements or the interaction between two elements, unless explicitly defined otherwise. The specific meanings of the above terms in the present disclosure can be understood by one of those ordinary skills in the art according to specific circumstances.

It should be noted that when an element is referred to as being “fixed to” or “provided on” another element, it can be directly on another element or there may be an intermediate element therebetween. When an element is considered to be “connected to” another element, it can be directly connected to another element or there may be an intermediate element therebetween at the same time. The terms “vertical”, “horizontal”, “upper”, “lower”, “left”, “right”, and the like used herein are for illustrative purposes only and are not intended to be the only embodiments.

According to the background, in the prior art, the flexspline of the harmonic speed reducer is usually fixed, and the circular spline drives the loaded component to rotate. Therefore, the length and weight of the transmission input shaft to which the flexspline and the circular spline are assembled are larger, which is disadvantageous to the dynamic response of the speed-reducing transmission mechanism. In order to improve the dynamic response of the speed-reducing transmission mechanism, the present disclosure provides a speed reducer and a speed-reducing transmission mechanism. The speed reducer is configured to achieve a reduction transmission from a transmission input shaft to a transmission output shaft, and includes a wave generator mounted to the transmission input shaft, a fixed circular spline, and a flexspline located between the circular spline and the wave generator. The flexspline includes a gear portion and a flange portion. The flange portion is configured to be connected to the transmission output shaft. The speed-reducing transmission mechanism includes: a transmission input shaft; a motor mounted at one end of the transmission input shaft; a speed reducer mounted at the other end of the transmission input shaft, and including a wave generator, a circular spline, and a flexspline located between the circular spline and the wave generators; and a transmission output shaft connected to the flexspline. The circular spline is fixedly connected. The flexspline includes a gear portion and a flange portion. The flange portion is connected to the transmission output shaft to achieve a reduction transmission from the transmission input shaft to the transmission output shaft.

In an operating process of the deceleration transmission, the wave generator rotates with the motor. During the flexspline rotating with the wave generator, when one tooth of the flexspline meshes with a tooth of the circular spline until it meshes with this tooth of the circular spline again, the flexspline rotates one turn, while the wave generator rotates many turns. A ratio of the number of the rotating turns of the wave generator to the number of the rotating turn (one turn) of the flexspline is a reduction ratio of the speed reducer. In this way, the rotating speed of the transmission input shaft is reduced by the speed reducer, so that the reduction transmission can be realized.

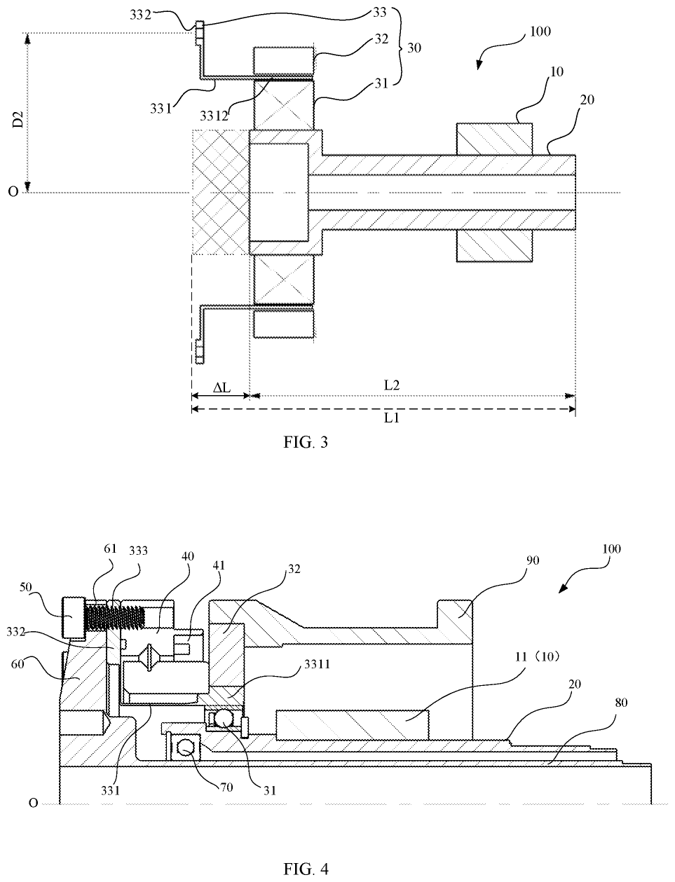

The configuration and advantages of the speed-reducing transmission mechanism according to the present disclosure will be described in detail below with reference to FIG. 3.

FIG. 3 is a schematic diagram of a speed-reducing transmission mechanism according to an embodiment of the present disclosure. The speed-reducing transmission mechanism 100 mainly includes a motor 10, a transmission input shaft 20, and a speed reducer 30. The motor 10 is fixedly mounted at one end of the transmission input shaft 20 and drives the transmission input shaft 20 to rotate. The motor 10 has a rotor. In some embodiments, the transmission input shaft 20 may be a rotor shaft of the motor.

In an embodiment, the speed-reducing transmission mechanism 100 further includes a housing, a stator, a brake assembly and other components. The housing and the stator are fixed components and are used to support the rotational motion of the transmission input shaft 20 and the rotational motion of the rotor of the motor 10. The brake assembly is used to provide braking force to the transmission input shaft 20. Since the housing, stator, brake assembly, etc. are common essential components in the speed-reducing transmission mechanism, the specific configurations of the housing, stator, brake assembly, etc. can be obtained from the prior art, for example, which are commercially available from the market as required, and the number of which can be increased and decreased as required, and which are not specifically limited herein. Due to the presence of necessary components such as the housing, the stator, and the brake assembly, the length of the transmission input shaft 20 is difficult to be shortened by reducing the number of these components or reducing the sizes of these components.

The speed reducer 30 is mounted at the other end of the transmission input shaft 20. The speed reducer 30 may include: a wave generator 31, mounted to the transmission input shaft 20; a fixed circular spline 32; and a flexspline 33, located between the circular spline 32 and the wave generator 31, including a gear portion and a flange portion. The wave generator 31 can be fixedly mounted on the transmission input shaft 20. The wave generator 31 has a cam structure. The circular spline 33 may be fixed to the housing of the speed-reducing transmission mechanism 100. The circular spline 33 refers to a spline with high rigidity.

In an embodiment of the present disclosure, the flexspline 33 is mounted between the wave generator 31 and the circular spline 32, to realize the reduction transmission of the speed reducer 30. The flexspline 33 is connected to a loaded component to drive the loaded component to rotate. Specifically, the flexspline 33 has a thin-walled cylindrical shape. The flexspline 33 has a cylindrical portion 331 and a flange portion 332. The flange portion 332 is connected to the loaded component. The loaded component is a structure that rotates together with the flexspline 33. In other words, the loaded component is an object to be driven by the flexspline 33. The loaded component is an object with a certain weight and is used to provide a suppressing force to the flexspline 33 so that the flexspline 33 generates a suppressing torque, which can help reduce the high rotation speed from the transmission input shaft 20. The suppressing torque will be further illustrated below. The loaded component is connected to the flexspline by a fastener. The fastener may be a screw, etc., which is not specifically limited herein.

In an embodiment of the present disclosure, the flange portion 332 of the flexspline 33 faces an outside of the wave generator 31. Herein, the outer side of the wave generator 31 is defined as a side of the wave generator 31 away from the motor 10, and correspondingly, an inner side of the wave generator 31 is defined as a side of the wave generator 31 adjacent to the motor 10. In an embodiment of the present disclosure, when the flexspline 33 is mounted to the transmission input shaft 20, the flexspline 33 is located between the wave generator 31 and the circular spline 32. Specifically, a gear portion 3311 of the cylindrical portion 331 of the flexspline 33 away from the flange portion 332 is located between the wave generator 31 and the circular spline 32, to achieve a transmission connection with the transmission input shaft 20, and the flange portion 332 of the flexspline 33 is connected to the loaded component. When the wave generator 31 rotates with the motor 10 at a high speed, the circular spline 32 is fixed to a housing of the speed-reducing transmission mechanism 100, and the wave generator 31 rotates and presses the flexspline 33 to cause the flexspline 33 to rotate at a low speed, and in turn, the flexspline 33 drives the loaded component connected thereto to rotate, thereby realizing the reduction transmission.

According to the present disclosure, by configuring the speed reducer 30 as described above, only the gear portion 3311 of the flexspline 33 of the speed reducer 30 (i.e., a portion away from the flange portion 332) is located between the wave generator 31 and the circular spline 32, The remaining portion (a portion except the gear portion 331) of the flexspline 33 of the speed reducer 30 is away from the transmission input shaft 20 and is connected to the loaded component, which means that the remaining portion of the flexspline 33 is not spatially mounted to the transmission input shaft 20, and thus the remaining portion of the flexspline 33 does not occupy the part mounting space on the transmission input shaft 20.

In the prior art, the flange portion of the flexspline is fixed to the housing of the speed-reducing transmission mechanism toward the inner side of the wave generator, and the portion of the cylindrical portion that is not located between the wave generator and the circular spline, and the flange portion of the flexspline will have to occupy the part mounting space on the transmission input shaft. However, in the present disclosure, by configuring the speed reducer 30 as described above, the portions of the flexspline 33 that is not located between the wave generator 31 and the rigid pinion 32 will not occupy the part mounting space on the transmission input shaft 20. Therefore, compared with the prior art, the configuration of the speed reducer 30 according to the present disclosure can save the part mounting space on the transmission input shaft 20. In this way, the length of the transmission input shaft 20 does not need to be too long, so that the length of the transmission input shaft 20 can be shortened. Specifically, as shown in FIG. 3, the length of the transmission input shaft in the prior art can be indicated by L1, and the length of the transmission input shaft 20 according to the present disclosure can be indicated by L2. The length reduction amount of the transmission input shaft 20 according to the present disclosure comparing with the prior art is indicated by ΔL, and ΔL=L1-L2. With this configuration, an axial size of the transmission input shaft 20 is reduced, so that the transmission input shaft 20 is easier to be processed, which can reduce the processing cost and material consumption of the speed-reducing transmission mechanism 100.

As the axial size of the transmission input shaft 20 is reduced, the weight of the transmission input shaft 20 is also reduced accordingly. The moment of inertia formula is known as follows:

$$J = m {r}^{∧} 2 ,$$

where J indicates the moment of inertia, m indicates the weight of the transmission input shaft 20, and r indicates a vertical distance from a center rotational axis O of the transmission input shaft 20 to the transmission input shaft 20. According to the moment of inertia formula, when the shape of the transmission input shaft 20 remains unchanged or r remains unchanged, when the weight of the transmission input shaft 20 decreases, the moment of inertia of the transmission input shaft 20 also decreases, thereby reducing the moment of inertia of a kinetic energy input end (i.e., an end where the motor 10 providing kinetic energy is located) of the speed-reducing transmission mechanism 100 can be reduced, which is beneficial to improve the dynamic response performance of the speed-reducing transmission mechanism.

In addition, since the speed reducer 30 is connected to the loaded component to achieve the reduction transmission, the speed reducer 30 can generate a suppressing torque relative to the kinetic energy input end of the speed-reducing transmission mechanism 100 to reduce the high rotational force of the transmission input shaft 20. The suppressing torque formula is known as follows:

$$T = μ F D ,$$

where T indicates the suppressing torque, F indicates the suppressing force, D indicates the suppressing force arm, and u indicates the suppressing coefficient.

In the present disclosure, the suppressing force arm D may refer to a distance from the connection between the speed reducer 30 and the loaded component to the center rotational axis O of the kinetic energy input end of the transmission input shaft 20 of the speed-reducing transmission mechanism 100.

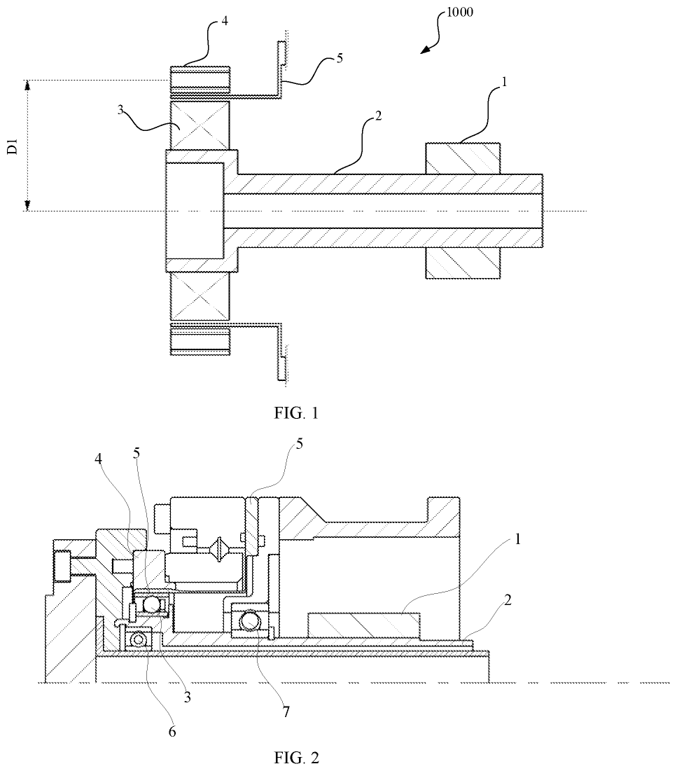

In the prior art, the flexspline is fixed to the housing of the speed-reducing transmission mechanism, and the circular spline is connected to the loaded component to achieve the reduction transmission. As shown in FIG. 1, the circular spline of the speed reducer connected to the loaded component can generate the suppressing torque relative to the kinetic energy input end, and the suppressing torque generated by the speed reducer can be indicated by T1=μF1D1. In the present disclosure, the circular spline 32 of the speed reducer 30 is fixed to the housing of the speed-reducing transmission mechanism 100, and the flexspline 33 is connected to the loaded component to achieve the reduction transmission. Specifically, the flange portion 332 of the flexspline 33 is connected to the loaded component, so that the flange portion 332 of the flexspline 33 of the speed reducer 30 generates the suppressing torque relative to the kinetic energy input end of the speed-reducing transmission mechanism 100, and the suppressing torque generated by the speed reducer 30 is indicated by T2=μF1D2. When the shape and configuration of the loaded component connected to the speed reducer 30 remain unchanged, F1=F2. However, since the flange portion 332 of the flexspline 33 is connected to the loaded component, and a distance from the flange portion 332 of the flexspline 33 to the center rotational axis O of the transmission input shaft 20 is greater than a distance from the circular spline 32 to the center rotational axis O of the transmission input shaft 20, the suppressing force arm D2 (see FIG. 3) of the speed reducer 30 according to the present disclosure is greater than the suppressing force arm D1 (see FIG. 1) of the speed reducer in the prior art, that is, D2>D1. Therefore, since F1=F2 and D1<D2, then T1<T2. That is, compared with the prior art, under the same space restriction conditions, the speed reducer 30 according to the present disclosure can generate a larger suppressing torque. In the case of speed reducers with the same specifications, compared with the prior art, the deformation of the flexspline 33 of the speed reducer 30 according to the present disclosure is smaller, thereby increasing the rigidity during the reduction transmission of the speed-reducing transmission mechanism 200, which is very advantageous to the reduction transmission of the speed-reducing transmission mechanism 200.

Specifically, the configuration of the speed-reducing transmission mechanism 100 and the advantages of the speed-reducing transmission mechanism 100 will be described in detail with reference to FIG. 4. As shown in FIG. 4, the speed-reducing transmission mechanism 100 may include the motor 10, including a rotor 11; the transmission input shaft 20; the speed reducer 30, mounted on the transmission input shaft 20, and including the wave generator 31, the circular spline 32, and the flexspline 33 located between the wave generator 31 and the circular spline 32, the flexspline 33 includes the cylinder portion 331 and the flange portion 332; a connecting member 60, connected to the flexspline 33; and a transmission output shaft 80, fixedly connected to the connecting member 60, and thereby connected to the speed reducer 30 via the connecting member 60; and the housing 90.

In an embodiment of the present disclosure, the speed reducer 30 is connected between the transmission input shaft 20 and the transmission output shaft 80, to perform the reduction transmission, and convert the high-speed motion from the transmission input shaft 20 into a low-speed motion, and transmit the low-speed motion to the transmission output shaft 80. Specifically, the circular spline 32 of the speed reducer 30 is fixed to the housing 90. The flange portion 332 of the flexspline 33 of the speed reducer 30 is connected to the loaded component (not shown).

In addition, the speed-reducing transmission mechanism 100 further includes a cross roller bearing 40. The cross roller bearing 40 is provided between the flange portion 332 of the flexspline 33 and the circular spline 32, to ensure the smooth rotation of the flexspline 33 relative to the circular spline 32. A bearing oil seal 41 may be provided at one end of the cross roller bearing 40 away from the flange portion 332, to prevent the leakage of oil inside the speed reducer 30 and ensure the normal operation of the speed reducer 30.

In an embodiment of the present disclosure, the connecting member 60 is connected to the flange portion 332 of the flexspline 33 through a fastener 50, thereby connecting the flange portion 332 of the flexspline 33 to the transmission output shaft 80. Thus, the speed reducer 30 can transmit the rotational motion from the transmission input shaft 20 to the transmission output shaft 80 via the connecting member 60. The fastener 50 may be, for example, a screw, a bolt, or the like. As long as the flange portion 332 of the flexspline 33 is firmly connected to the connecting member 60, the fastener 50 can have any configuration, which is not specifically limited herein.

The connecting member 60 may be provided with a first mounting hole 61. The flange portion 332 of the flexspline 33 may be provided with a second mounting hole 333. The cross roller bearing 40 may be provided with a third mounting hole. Positions of the first mounting hole 61, the second mounting hole 333, and the third mounting hole correspond to each other. The fastener 50 can be mounted in the first mounting hole 61, the second mounting hole 333 and the third mounting hole to fix the connecting member 60, the flexspline 33 and the cross roller bearing 40 together. In one of the embodiments, the loaded component may be directly connected to the flange portion 332 of the flexspline 33 through the first mounting hole 61 and the second mounting hole 72 via the fastener 50. In other embodiments, the connecting member 60 may be provided with other mounting holes (not shown) to be connected to the loaded component, so that the loaded component may provide the suppressing force to the flange portion 332 of the flexspline 33 of the speed reducer 30 to help reduce the high rotational force of the rotor 11 of the motor 10. That is, the loaded component may be connected to the flange portion 332 of the flexspline 33 via the connecting member 60. Since the speed speed reducer 30 transmits the rotational motion from the transmission input shaft 20 to the transmission output shaft 80 via the flange portion 332 of the flexspline 33, as long as the loaded component can provide the suppressing force to the flange portion 332 of the flexspline 33, the speed reducer 30 can generate the suppressing torque from the flange portion 332 of the flexspline 33 to the center rotational axis O of the transmission input shaft 20, regardless of the mounting position of the loaded component relative to the flange portion 332. Therefore, no matter whether the loaded component is directly connected to the flange portion 332 of the flexspline 33 or indirectly connected to the flange portion 332 of the flexspline 33, it does not affect the suppressing torque, which mainly depends on the weight of the loaded component and the position of the portion of the speed reducer 30 connected to the loaded component. Therefore, the loaded component and the connecting member 60 may be two independent components, or may be integrally formed, which is not specifically limited herein.

In addition, the transmission input shaft 20 and the transmission output shaft 80 are coaxially mounted. The transmission input shaft 20 is sleeved over the transmission output shaft 80. The speed-reducing transmission mechanism 100 further includes a support bearing 70. The support bearing 70 is used to support the transmission input shaft 20 and the transmission output shaft 80, to ensure the smooth rotation of the transmission input shaft 20 and the transmission output shaft 80. The support bearing 70 is mounted on the transmission input shaft 20 through a bearing retainer ring. Specifically, the transmission input shaft 20 may be provided with a groove. The bearing retainer ring is mounted in the groove.

As described above, since the flange portion 322 of the flexspline 33 of the speed reducer 30 according to the present disclosure faces the outside of the wave generator, the space occupied by the flexspline 33 on the transmission input shaft 20 is greatly reduced, so that the length of the transmission input shaft 20 can be reduced. Therefore, the configuration of the speed-reducing transmission mechanism 100 according to the present disclosure is more compact compared to the prior art. Only one supporting bearing 70 can be provided, and the normal operation of the speed-reducing transmission mechanism 100 can be ensured. Further, since the weight of the bearing for supporting rotation in the speed-reducing transmission mechanism 100 is reduced, the weight of the kinetic energy input end of the speed-reducing transmission mechanism 100 is also further reduced, which is beneficial to reduce the moment of inertia of the kinetic energy input end of the speed-reducing transmission mechanism 100.

In addition, in the speed-reducing transmission mechanism according to the prior art, when the circular spline is connected to the loaded component and the flexspline is fixed to, for example, the housing of the speed-reducing transmission mechanism, the transmission input shaft has a longer length, and thus the speed-reducing transmission mechanism needs to include at least two bearings, for example, a first bearing and a second bearing, to ensure the normal rotation of the transmission input shaft. As shown in FIG. 2, the first bearing 6 is mounted between the transmission input shaft and the transmission output shaft, to support the transmission input shaft and the transmission output shaft and ensure the normal rotation of the transmission input shaft and the transmission output shaft. The second bearing 7 is mounted between the flexspline 5 and the transmission input shaft to support the transmission input shaft and ensure the normal rotation of the transmission input shaft. The first bearing 6 and the second bearing 7 are respectively mounted on the transmission input shaft through a first bearing retainer ring and a second bearing retainer ring. Thus, the transmission input shaft is required to be provided with a first mounting groove and a second mounting groove, to mount the first bearing retainer ring and the second bearing retainer ring respectively. In this way, the transmission input shaft will inevitably be provided with at least two mounting grooves for mounting the bearing retainer rings, and will inevitably have a larger weight. Moreover, the more grooves on the transmission input shaft, the more portions of the transmission input shaft where stress concentration occurs, and the greater the load on the transmission input shaft, which will accelerate the wear of the transmission input shaft.

However, in the speed-reducing transmission mechanism 100 according to the present disclosure, the circular spline 32 of the speed reducer 30 is fixed to the housing 90 of the speed-reducing transmission mechanism 100, and the flexspline 32 is connected to the loaded component through the flange portion 332 thereof. The speed-reducing transmission mechanism 100 may be provided with only one support bearing 70. Compared with the prior art as described above, in this disclosure, the number of support bearings is greatly reduced, so that the number of bearing retainer rings used to mount the support bearings is reduced, and thus, the number of grooves used for the mounting the bearing retainer rings on the transmission input shaft 20 is reduced, which greatly reduces the number of portions on the transmission input shaft 20 where stress concentration occurs. Further, this can make the force on the transmission input shaft 20 more uniform, and reduce the wear of the transmission input shaft 20.

In addition, since the number of support bearings is reduced, the length of the transmission input shaft 20 can be further reduced. Further, the length of the transmission output shaft 80 can be reduced accordingly. This can greatly reduce the weight of the kinetic energy input end of the entire speed-reducing transmission mechanism 100, reduce the ineffective loss during the reduction transmission process, and improve the dynamic response performance of the speed-reducing transmission mechanism 100. Since it is not necessary for the transmission input shaft 20 to be provided with many grooves for mounting the bearing retainer rings, the manufacture and mounting of the transmission input shaft 20 can be facilitated, thereby facilitating the mounting of the speed-reducing transmission mechanism 100.

Those skilled in the art can understand that the configurations shown in FIG. 3 and FIG. 4 are only various examples of the embodiments of the present disclosure, and do not form a limitation on the application of the technical solution of the present disclosure in other devices.

According to various embodiments of the present disclosure, a robot joint is further provided. The robot joint may include a clamping jaw; the speed-reducing transmission mechanism 100 as described above. The clamping jaw is connected to a kinetic energy output end of the speed-reducing transmission mechanism 100. The speed-reducing transmission mechanism 100 includes: a transmission input shaft; a motor mounted at one end of the transmission input shaft; a speed reducer mounted at the other end of the transmission input shaft, and including a wave generator, a circular spline, and a flexspline located between the circular spline and the wave generators; and a transmission output shaft connected to the flexspline. The circular spline is fixedly connected. The flexspline includes a gear portion and a flange portion. The flange portion is connected to the transmission output shaft to achieve a reduction transmission from the transmission input shaft to the transmission output shaft. Specifically, the clamping jaw is connected to the transmission output shaft.

According to various embodiments of the present disclosure, a robot is further provided. The robot may include the robot joint as described above.

Compared with the prior art, the robot joint and robot can have a relatively compact structure, can save processing costs and material consumption, and have higher dynamic response performance.

The technical features of the above-described embodiments can be combined arbitrarily. To simplify the description, not all possible combinations of the technical features in the above embodiments are described. However, all of the combinations of these technical features should be considered as being fallen within the scope of the present disclosure, as long as such combinations do not contradict with each other.

The foregoing embodiments merely illustrate some embodiments of the present disclosure, and descriptions thereof are relatively specific and detailed. However, it should not be understood as a limitation to the patent scope of the present disclosure. It should be noted that, a person of ordinary skill in the art may further make some variations and improvements without departing from the concept of the present disclosure, and the variations and improvements falls in the protection scope of the present disclosure. Therefore, the protection scope of the present disclosure shall be subject to the appended claims.

What is claimed is:

1. A speed reducer, configured to achieve a reduction transmission from a transmission input shaft to a transmission output shaft, comprising:
a wave generator mounted to the transmission input shaft;
a fixed circular spline; and
a flexspline located between the circular spline and the wave generator, and comprising a gear portion and a flange portion;
wherein the flange portion is configured to be connected to the transmission output shaft.

2. The speed reducer according to claim 1, wherein a loaded component is connected to the flange portion.

3. (canceled)

4. The speed reducer according to claim 1, wherein a distance from the flange portion to a center rotational axis of the transmission input shaft is greater than a distance from the circular spline to the center rotational axis of the transmission input shaft.

5. A speed-reducing transmission mechanism, comprising:
a transmission input shaft;
a motor mounted at one end of the transmission input shaft;
a speed reducer mounted at the other end of the transmission input shaft, and comprising a wave generator, a circular spline, and a flexspline located between the circular spline and the wave generators; and
a transmission output shaft connected to the flexspline;
wherein the circular spline is fixedly connected; the flexspline comprises a gear portion and a flange portion; the flange portion is connected to the transmission output shaft, to achieve a reduction transmission from the transmission input shaft to the transmission output shaft.

6. The speed-reducing transmission mechanism according to claim 5, wherein a loaded component is connected to the flexspline.

7. The speed-reducing transmission mechanism according to claim 5, wherein the flange portion faces a side of the wave generator away from the motor.

8. The speed-reducing transmission mechanism according to claim 5, wherein the wave generator is mounted on the other end of the transmission input shaft, and the motor, the transmission input shaft and the wave generator rotate synchronously.

9. (canceled)

10. The speed-reducing transmission mechanism according to claim 5, further comprising a housing, wherein the circular spline is fixed to the housing.

11. The speed-reducing transmission mechanism according to claim 5, wherein a distance from the flange portion to a center rotational axis of the transmission input shaft is greater than a distance from the circular spline to the center rotational axis of the transmission input shaft.

12. The speed-reducing transmission mechanism according to claim 6, wherein the loaded component is directly connected to the flange portion of the flexspline via a fastener.

13. The speed-reducing transmission mechanism according to claim 5, further comprising a connecting member, wherein the connecting member is connected to the flange portion of the flexspline via a fastener, and is fixedly connected to the transmission output shaft.

14. The speed-reducing transmission mechanism according to claim 13, wherein a loaded component is fixedly connected to the connecting member.

15. The speed-reducing transmission mechanism according to claim 14, wherein the loaded component and the connecting member are two independent components, or are integrally formed.

16. The speed-reducing transmission mechanism according to claim 13, wherein the connecting member is provided with a first mounting hole; the flange portion is provided with a second mounting hole; a position of the first mounting hole corresponds to a position of the second mounting hole; a loaded component and the connecting member are connected to the flange portion via the fastener.

17. The speed-reducing transmission mechanism according to claim 5, further comprising a support bearing mounted on the transmission input shaft.

18. The speed-reducing transmission mechanism according to claim 17, wherein one support bearing is provided.

19. The speed-reducing transmission mechanism according to claim 5, further comprising a cross roller bearing provided between the flange portion of the flexspline and the circular spline.

20. (canceled)

21. The speed-reducing transmission mechanism according to claim 5, wherein the transmission input shaft and the transmission output shaft are coaxially mounted, and the transmission input shaft is sleeved over the transmission output shaft.

22. (canceled)

23. A robot joint, comprising the speed-reducing transmission mechanism according to claim 5.

24. A robot, comprising the robot joint according to claim 23.
